(19) United States
(12) Patent Application Publication
(10) Pub. No.: US 2011/0117840 A1
(43) Pub. Date: May 19, 2011

(54) Bluetooth Earphone And Host Device Using The Bluetooth Earphone

(76) Inventor: Zhi Li, Shanghai (CN)

(21) Appl. No.: 12/670,674

(22) PCT Filed: Jul. 26, 2007
(86) PCT No.: PCT/CN2007/070357

§ 371 Date: Nov. 20, 2010

(51) Int. Cl. H04W 24/00; H04W 88/02

(52) U.S. Cl. 455/41.2; 455/569.1

(57) ABSTRACT

Embodiments of the present disclosure provide a Bluetooth earphone and a host device using Bluetooth earphone, which are capable of providing an automatic switch of the Bluetooth earphone. According to an embodiment of the present disclosure, the Bluetooth earphone and the host device may perceive each other. When the Bluetooth earphone is in use, the earphone and the Bluetooth module of the host device will be switched on automatically, and a connection thereof will also be built automatically. When the Bluetooth earphone is not in use, the earphone and the Bluetooth module of the host device will be switched off automatically to save power. Embodiments of the present disclosure further provide a new charging mode of the Bluetooth earphone. Therefore, the Bluetooth earphone will no longer use a separate charging device, instead, the host device will take the responsibility for charging the Bluetooth earphone. Embodiments of the present disclosure further provide a lodging space at the host device for lodging the Bluetooth earphone. When not in use, the Bluetooth earphone may be placed at the lodging space.

### FIELD OF THE INVENTION

The present disclosure relates to Bluetooth technique, and more specifically, to Bluetooth earphone and host device using Bluetooth earphone.

### BACKGROUND

With the development of the Bluetooth technology, the Bluetooth earphone has been employed extensively, and has facilitated users in many aspects. For instance:
1. the Bluetooth earphone has a wireless microphone, which may avoid the inconvenience by using a wire microphone;
2. the Bluetooth earphone may he so mini as to be easily fit over the ear, and the hand is thereby set free, which brings quite a facilitation for the user.

As embracing the aforementioned advantages, the application of Bluetooth earphone is becoming prevalent. Currently, for usage of Bluetooth microphone, a Bluetooth device is installed in various personal terminals such as a mobile phone, a Personal Digital Assistant (PDA), a notebook, etc.

However, the existing Bluetooth mobile phone still suffers from the following problems.

1. A procedure of using a Bluetooth earphone is usually performed as follows:
a. switch on a Bluetooth module battery of the host device;
b. switch on a Bluetooth earphone battery to keep the Bluetooth earphone in a searchable status, and generally, such function is realized by a multi-function button for most of Bluetooth earphones;
c. search the Bluetooth earphone by the host device, since the Bluetooth is a wireless communication technique which covers a certain operation range, usually, the host device may simultaneously find out several Bluetooth earphones (or other devices having the Bluetooth module) within the operation range. Next, determine a desired Bluetooth earphone;
d. input PIN code of the host device in order to set up a connection with the Bluetooth earphone, such that the host device may connect with the Bluetooth earphone, which also needs several seconds.

Apparently, this procedure is complex and time-consuming, and is not quite convenient to the user. Moreover, for each time if either the host device or the Bluetooth earphone is switched off, the aforementioned procedure should thereafter be repeated to restart the Bluetooth device.

2. Since the aforementioned procedure of search and connection building is very complex and time-consuming, the user needs to simultaneously keep both the Bluetooth earphone and the host device power on to cope with possible incoming calls. This will be a procedure with much power consumption. Since both the host device and the Bluetooth earphone are hand held devices relying on batteries for work, it may consume much power to keep the Bluetooth power on for a long period, and may tremendously shorten the standby period of the host device and the Bluetooth earphone. This brings much inconvenience to the user.

3. Separated host device and Bluetooth earphone have different battery capacity, such that charging period and standby/usage period of the two devices are also different. Unfortunately, both the host device and the Bluetooth earphone have to be switched on when using the two devices. In other words, when the battery of any of the two devices is used up, the Bluetooth earphone will not function any more. As a result, the user has to pay attention to the remaining capacity of both of the two devices during usage, which places extra burden on the user. In addition, the two devices have different charging period, the user must wait until both of the two devices complete the charging, and thereafter, the user may use the Bluetooth function normally.

4. As an independent device, the existing Bluetooth earphone uses its own separate charger. Consequently, the user has to take two different chargers for a trip. This is quite inconvenience accordingly.

5. There also lies much inconvenience during usage. For instance, when a conversation is completed, the user needs to consider whether to switch off the Bluetooth earphone and the Bluetooth module of the host. The user also needs to check whether the two devices are connected normally, and whether the remaining capacity is adequate. Any one of the aforementioned factors may cause the disconnection between the Bluetooth earphone and the host device. However, it takes relatively a long time to rebuild the connection. If an incoming call occurs while no connection is built between the devices, the user has no time to build the Bluetooth connection.

6. Although the Bluetooth earphone is a mini device, it is still uncomfortable to wear it over the ear for a long time. Furthermore, the Bluetooth earphone is easily to be broken by accident when wearing it over the ear all day long. For instance, exposure to rain, insulation, or accident stroke may cause the damage of the Bluetooth earphone. Meanwhile, the user hopes that the Bluetooth earphone can be as small as possible for carrying. When the Bluetooth earphone is pulled out, however, the user may usually leave the Bluetooth earphone at some inter space due to its small size, thus, the Bluetooth earphone is always nowhere to be found. Herein, the user is placed in a dilemma in terms of the Bluetooth earphone size.

In summary, the Bluetooth technique, especially the Bluetooth earphone, facilitates the conversation for users. However, the existing Bluetooth earphone has a lot of defects which affect user experience, and needs further improvements.

### SUMMARY

The present disclosure provides a new Bluetooth earphone and a host device using Bluetooth earphone, which are capable of realizing an automatic switch of the Bluetooth earphone. According to the present disclosure, the Bluetooth earphone and the host device may perceive each other. When the Bluetooth earphone is in use, the earphone and the Bluetooth module of the host device will be switched on automatically, and a connection will also be built automatically. When the Bluetooth earphone is not in use, the earphone and the Bluetooth module of the host device will be switched off automatically to save power.

The present disclosure further provides a new charging mode of the Bluetooth earphone. The Bluetooth earphone will no longer use a separate charging device, instead, the host device will take the responsibility for charging the Bluetooth earphone. As such, the two devices may share substantially the same standby/usage period and charging period. Also, there is no need to carry two chargers any more.

The present disclosure further provides lodging space at the host device for lodging the Bluetooth earphone. When not in use, the Bluetooth earphone may be placed at the lodging space. Accordingly, the Bluetooth earphone will no longer be nowhere to be found.

According to one aspect of the present disclosure, a Bluetooth earphone is provided. The Bluetooth earphone is placed at a slot of a host device using the Bluetooth earphone; and the Bluetooth earphone has detection apparatus. The detection apparatus detects whether the Bluetooth earphone is located in the slot, if the Bluetooth earphone is located in the slot, the detection apparatus instructs the Bluetooth earphone to switch off, and if the Bluetooth earphone is located outside the slot, the detection apparatus instructs the Bluetooth earphone to switch on.

According to one embodiment, the Bluetooth earphone comprises an automatic connection apparatus. The automatic connection apparatus automatically matches with the host device using the Bluetooth earphone when the detection apparatus indicates that the Bluetooth earphone is located in the slot and no matching is performed yet; whereas the automatic connection apparatus automatically builds a connection with the host device when the detection apparatus indicates that the Bluetooth earphone is located outside the slot. The Bluetooth earphone further comprises a charging apparatus. The charging apparatus matches with the slot via which charging for the Bluetooth earphone is performed by the host device using the Bluetooth earphone.

According to another aspect of the present disclosure, a host device using Bluetooth earphone is provided. The host device using Bluetooth earphone comprises: at least one slot, each connected to the Bluetooth earphone; an earphone status detection detecting whether the Bluetooth earphone is located in the slot, if the earphone status detection apparatus determines that the Bluetooth earphone is located outside the slot, a communication channel is built with the Bluetooth earphone and an audio communication channel is transferred to the Bluetooth earphone, and then a main audio conversation device of the host device is switched off after successful completion; if the earphone status detection apparatus determines that the Bluetooth earphone is located in the slot, the main audio conversation device of the host device is switched on, and the audio communication channel is transferred to the main audio conversation device.

According to one embodiment, the host device comprises an earphone automatic connection enabling apparatus. The earphone automatic connection enabling apparatus automatically builds a connection with the Bluetooth earphone when the earphone status detection apparatus indicates that the Bluetooth earphone is located outside the slot. The host device further comprises an earphone charging apparatus. The earphone charging apparatus charges the Bluetooth earphone via the slot, and the earphone charging apparatus switches on the charging channel for the Bluetooth earphone when the earphone status detection apparatus determines that the Bluetooth earphone is located in the slot, such that the charging apparatus of the Bluetooth earphone automatically detects whether charging is required; whereas the earphone charging apparatus switches off the charging channel for the Bluetooth earphone when the earphone status detection apparatus determines that the Bluetooth earphone is located outside the slot.

According to one embodiment, the host device comprises an automatic control switch, when the automatic control switch is switched on, the host device transfers the audio communication channel and provides the charging channel based on a determination result conducted by the earphone status detection apparatus; when the automatic control switch is switched off, the host device merely provides the charging channel based on the determination by the earphone status detection apparatus.

According to a third aspect of the present disclosure, a host device having Bluetooth earphone is provided. The host device having Bluetooth earphone comprises: a Bluetooth earphone, which has a detection apparatus, wherein the detection apparatus detects whether the Bluetooth earphone is located in the slot, and the detection apparatus instructs the Bluetooth earphone to switch off when the Bluetooth earphone is located in the slot, whereas the detection apparatus instructs the Bluetooth earphone to switch on when the Bluetooth earphone is located outside the slot; at least one slot, each connected to the Bluetooth earphone; and an earphone status detection apparatus, wherein the earphone status detection apparatus detects whether the Bluetooth earphone is located in the slot, when the earphone status detection apparatus determines that the Bluetooth earphone is located outside the slot, a communication channel is built with the Bluetooth earphone and an audio communication channel is transferred to the Bluetooth earphone, and then a main audio conversation device of the host device is switched off after successful completion; when the earphone status detection apparatus determines that the Bluetooth earphone is located in the slot, the main audio conversation device of the host device is switched on, and the audio communication channel is transferred to the main audio conversation device.

According to one embodiment, the Bluetooth earphone comprises an automatic connection apparatus. The automatic connection apparatus automatically matches with the host device using the Bluetooth earphone when the detection apparatus indicates that the Bluetooth earphone is located in the slot and no matching is performed yet; whereas the automatic connection apparatus automatically builds a connection with the host device when the detection apparatus indicates that the Bluetooth earphone is located outside the slot. The host device comprises an earphone automatic connection enabling apparatus. The earphone automatic connection enabling apparatus automatically builds a connection with the Bluetooth earphone when the earphone status detection apparatus indicates that the Bluetooth earphone is located outside the slot. The Bluetooth earphone comprises a charging apparatus. The charging apparatus matches with the slot via which charging for the Bluetooth earphone is performed by the host device using the Bluetooth earphone, when the detection apparatus indicates that the Bluetooth earphone is located in the slot, the charging apparatus of the Bluetooth earphone automatically detects whether charging is required; when the charging is required, the charging apparatus automatically charges the Bluetooth earphone via the slot by the host device using the Bluetooth earphone. The host device comprises an earphone charging apparatus. The earphone charging apparatus charges the Bluetooth earphone via the slot, and the earphone charging apparatus switches on the charging channel for the Bluetooth earphone when the earphone status detection apparatus determines that the Bluetooth earphone is located in the slot, such that the charging apparatus of the Bluetooth earphone automatically detects whether charging is required; whereas the earphone charging apparatus switches off the charging channel for the Bluetooth earphone when the earphone status detection apparatus determines that the Bluetooth earphone is located outside the slot.

According to one embodiment, the host device has at least a lodging space, and the profile of the lodging space matches with the profile of the Bluetooth earphone. Each lodging space has a slot and lodges the whole Bluetooth earphone.

According to the present disclosure, automatic switching on/off the Bluetooth earphone is provided, so that the Bluetooth earphone and the host device may perceive each other. When the Bluetooth earphone is in use, the earphone and the Bluetooth module of the host device will be switched on automatically, and a connection thereof will also be built automatically. When the Bluetooth earphone is not in use, the earphone and the Bluetooth module of the host device will be switched off automatically to save power. According to the present disclosure, the Bluetooth earphone will no longer use a separate charging device, instead, the host device will take the responsibility for charging the Bluetooth earphone. As such, the two devices may share substantially the same standby/usage period and charging period. Also, there is no need to carry two chargers any more. The present disclosure further provides lodging space at the host device for lodging the Bluetooth earphone. When not in use, the Bluetooth earphone may be placed at the lodging space. Accordingly, the Bluetooth earphone will no longer be nowhere to be found.

### BRIEF DESCRIPTION OF THE DRAWINGS

The foregoing and other features, characters and advantages of the present disclosure will become more readily appreciated by reference to the following description of the embodiments, when taken in conjunction with the accompanying drawings where the same reference sign in the drawings always represents the same feature, wherein,

FIG. 1 illustrates a schematic view of a Bluetooth earphone according to a first embodiment of the present disclosure;

FIG. 2 illustrates a schematic view of a Bluetooth earphone according to a second embodiment of the present disclosure;

FIG. 3 illustrates a schematic view of a Bluetooth earphone according to a third embodiment of the present disclosure;

FIG. 4 illustrates a schematic view of a host device using Bluetooth earphone according to a first embodiment of the present disclosure;

FIG. 5 illustrates a schematic view of a host device using Bluetooth earphone according to a second embodiment of the present disclosure;

FIG. 6 illustrates a schematic view of a host device using Bluetooth earphone according to a third embodiment of the present disclosure;

FIG. 7 illustrates a schematic view of a host device using Bluetooth earphone according to a fourth embodiment of the present disclosure;

FIG. 8 illustrates a schematic view of a host device using Bluetooth earphone according to a fifth embodiment of the present disclosure;

FIG. 9 illustrates a schematic view of a host device using Bluetooth earphone according to a sixth embodiment of the present disclosure;

FIG. 10 illustrates a schematic view of a host device having Bluetooth earphone according to a first embodiment of the present disclosure;

FIG. 11 illustrates a schematic view of a host device having Bluetooth earphone according to a second embodiment of the present disclosure;

FIG. 12 illustrates a schematic view of a host device having Bluetooth earphone according to a third embodiment of the present disclosure;

FIG. 13 illustrates a schematic view of a host device having Bluetooth earphone according to a fourth embodiment of the present disclosure;

FIG. 14 illustrates a schematic view of a host device having Bluetooth earphone according to a fifth embodiment of the present disclosure; and

FIG. 15 illustrates a schematic view of a host device having Bluetooth earphone according to a sixth embodiment of the present disclosure.

### DETAILED DESCRIPTION

The present disclosure is directed to solve the problems including:

1. A new Bluetooth earphone and a host device using Bluetooth earphone are provided, which are capable of providing an automatic switch of the Bluetooth earphone. According to an embodiment of the present disclosure, the Bluetooth earphone and the host device may perceive each other. When the Bluetooth earphone is in use, the earphone and the Bluetooth module of the host device will be switched on automatically, and a connection will also be built automatically. When the Bluetooth earphone is not in use, the earphone and the Bluetooth module of the host device will be switched off automatically to save power.

2. A new charging mode of the Bluetooth earphone is provided, the Bluetooth earphone will no longer use a separate charging device, instead, the host device will take the responsibility for charging the Bluetooth earphone. As such, the two devices may share substantially the same standby/usage period and charging period. Also, there is no need to carry two chargers any more.

3. Lodging space at the host device is provided for lodging the Bluetooth earphone according to an embodiment of the present invention. When not in use, the Bluetooth earphone may be placed at the lodging space. Accordingly, the Bluetooth earphone will no longer be nowhere to be found.

An embodiment of the present disclosure provides a Bluetooth earphone, a host device using Bluetooth earphone, and a host device having Bluetooth earphone.

### Bluetooth Earphone

For the automatic switch of the Bluetooth earphone, a mechanism of automatic switch of the Bluetooth earphone is provided according to an embodiment of the present disclosure. The Bluetooth earphone is plugged into a slot of the host device. When not in use, the Bluetooth earphone remains in the slot, whereas the Bluetooth earphone is pulled out of the slot when required for use. The Bluetooth earphone is plugged back to the slot again after use. As such, the usage status of the Bluetooth earphone may be acquired by simply monitoring the Bluetooth earphone of being “plugged into/pulled out” of the slot (accidentally slipping out or dropping off the Bluetooth earphone from the slot is not considered while only normal usage status is considered herein). The automatic switch of the Bluetooth earphone may be realized by using the technique similar to “plug and play” or USB interface of computer system.

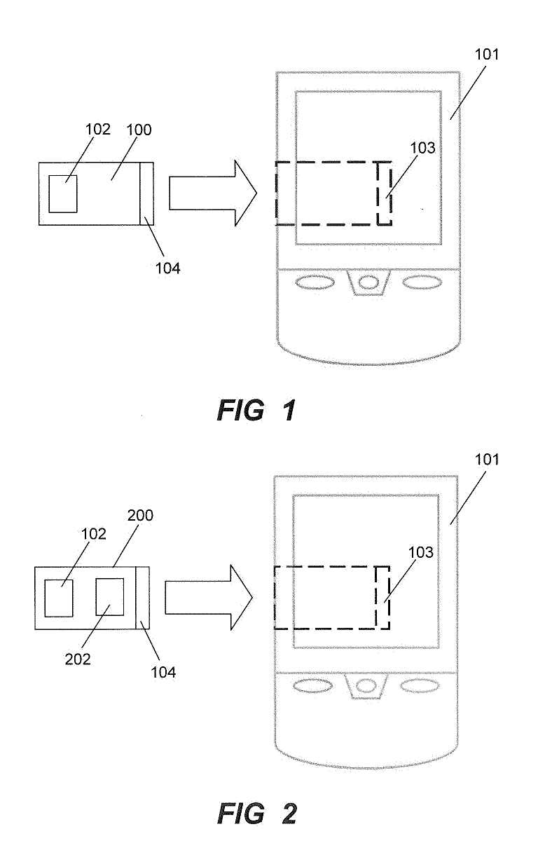

As shown in FIG. 1, a schematic view of a Bluetooth earphone according to a first embodiment of the present disclosure is illustrated. The Bluetooth earphone 100 is placed at a slot 103 of a host device 101, and the Bluetooth earphone 100 is capable of perceiving whether it is located in the slot 103. Therefore, besides the same basic structure as existing Bluetooth earphone (the basic structure is well-known in the art and a detailed description thereof is omitted herein for brevity), the Bluetooth earphone 100 further includes: a detection apparatus 102 for detecting whether the Bluetooth earphone 100 is located in the slot 103. When the Bluetooth earphone 100 is located in the slot 103, the detection apparatus 102 instructs the Bluetooth earphone 100 to switch off the power. When the Bluetooth earphone 100 is located outside the slot 103, the detection apparatus 102 instructs the Bluetooth earphone 100 to switch on the power.

The Bluetooth earphone 100 may be automatically switched on/off with the detection apparatus 102. When the Bluetooth earphone 100 is located in the slot 103, indicating that the Bluetooth earphone 100 is not in use, its power is therefore switched off to reduce power consumption. When the detection apparatus 102 determines that the Bluetooth earphone 100 is located outside the slot 103, indicating that the Bluetooth earphone 100 is pulled out and should he in use, the detection apparatus 102 then instructs the Bluetooth earphone 100 to switch on the power for use. When the Bluetooth earphone 100 is placed back to the slot 103 after use, the detection apparatus 102 determines that the Bluetooth earphone 100 is not in use, and then switches off the power of Bluetooth earphone 100 again.

As mentioned above, such a monitoring of “plug into/pull out” is achievable using the technique of “plug and play” or USB interface according to the existing computer system. Therefore, application of such technique into the Bluetooth earphone 100 is fully achievable to those skilled in the art. Consequently, it is important that an implementation thereof is provided according to the embodiments of the present disclosure, i.e., achieving the control of automatic switch of Bluetooth earphone by monitoring “plug into/pull out” of Bluetooth earphone. However, the present disclosure is not intended to limit its specific solutions, e.g., specific circuit and control software, which are achievable to those skilled in the art when the existing technique is adopted.

Referring to FIG. 1, the Bluetooth earphone 100 further includes at least one socket 104, where the at least one socket 104 matches with the slot 103, when the at least one socket 104 is in contact with the slot 103, the detection apparatus 102 determines that the Bluetooth earphone 100 is located in the slot 103, when the at least one socket 104 is separated from the slot 103, the detection apparatus 102 determines that the Bluetooth earphone 100 is located outside the slot 103. It should be noted that although only one socket 104 is illustrated in FIG. 1, as can be appreciated, the Bluetooth earphone 100 may further include a plurality of sockets 104 that measure with various standards in order to match with possibly different slot 103 of the host device 101. As to be mentioned below, the host device may include various personal terminals such as a mobile phone, a PDA, a notebook, etc. These terminals may have various types of slots, accordingly, the Bluetooth earphone 100 proposed by the embodiments of the present disclosure may have a plurality of different sockets to facilitate the generality of Bluetooth earphone 100.

Similar to the well-known Bluetooth earphone, the operating voltage of this Bluetooth earphone may be 1.2V-3.7V, and the charging voltage may be 3.7V-18.5V. The host device may supply the charging voltage of 3.7V-18.5V accordingly. It should be noted that the aforementioned operating voltage and charging voltage of Bluetooth earphone may be modified in different actual circumstances, which is appreciable to those skilled in the art.

The Bluetooth earphone according to the embodiments of the present disclosure may include, but not limited to a mono channel Bluetooth earphone, a stereo Bluetooth earphone, or a set of mono channel earphones, including a left channel and a right channel.

As aforementioned, in terms of the Bluetooth earphone and the host device, after achieving the automatic switch, the next issue to be addressed is automatic matching and connection building. In prior art, connection building requires a manual search by user, a selection of a Bluetooth earphone, an input of PIN code of the host device, which is quite a time-consuming and laborious procedure. Therefore, it is also desirable to have an optimization thereof.

As shown in FIG. 2, a schematic view of a Bluetooth earphone according to a second embodiment of the present disclosure is illustrated, namely a further optimization for the embodiment shown in FIG. 1 with the function of automatic matching added therein.

As shown in FIG. 2, based on the embodiment 100 in FIG. 1 (the description of same components as those of the embodiment 100 in FIG. 1 is omitted herein), Bluetooth earphone 200 further includes an automatic connection apparatus 202 for automatically matching with the host device 101 using the Bluetooth earphone, when the detection apparatus 102 indicates that the Bluetooth earphone 200 is located in the slot 103 and no matching is performed yet. The automatic connection apparatus also automatically builds a connection with the host device 101 when the detection apparatus 102 indicates that the Bluetooth earphone 200 is located outside the slot 103. The procedure of automatic matching and connection building is similar to that of the manual operation, however, automatic connection may be realized by using information of the Bluetooth earphone and PIN code information stored in the host device. This procedure is operated in a way similar to that of storing an account number and key in computer for an automatic login, which is fully achievable to those skilled in the art.

The charging for Bluetooth earphone is yet another issue to be addressed. The charging for Bluetooth earphone is handed over to the host device according to the embodiments of the present disclosure, thus no separate charger is needed for charging the Bluetooth earphone. Consequently, the charging for host device and Bluetooth earphone will be performed synchronously such that the charging period of the two devices may be synchronous. Moreover, according to the design of the present disclosure, the host device may charge the Bluetooth earphone by host device battery or by external power source of the host device. Therefore, the Bluetooth earphone itself may be designed to have a low battery capacity which is adequate to support a certain conversation period. When located at the socket of host device, the Bluetooth earphone will be charged by the host device until full. Since the host device may use its own battery to charge the Bluetooth earphone, standby period of the two devices may be substantially synchronous accordingly.

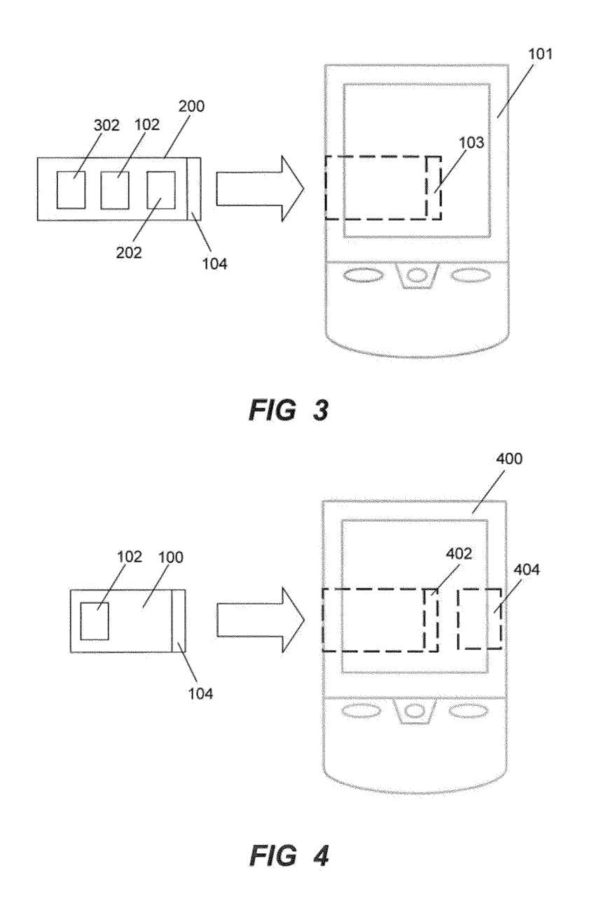

Consequently, as shown in FIG. 3, a schematic view of a Bluetooth earphone according to a third embodiment of the present disclosure is illustrated in FIG. 3, namely a further optimization for the embodiment of the present disclosure. The function of automatic charging is added therein.

As shown in FIG. 3, based on the embodiment 200 in FIG. 2 (the description of same components as those of the embodiment 200 in FIG. 2 is omitted herein), a charging apparatus 302 is further added into a Bluetooth earphone 300, where the charging apparatus 302 matches with the slot 103 via which charging for the Bluetooth earphone is performed by the host device 101. When the detection apparatus 102 indicates that the Bluetooth earphone is located in the slot 103, the charging apparatus 302 of the Bluetooth earphone 300 automatically detects whether charging is required. When the charging is required, the charging apparatus 302 automatically charges the Bluetooth earphone 300 via the slot 103, the charging is supported by the host device 101. Further referring to FIG. 3, the charging apparatus 302 is connected to the at least one socket 104 through which the host device 101 charges the Bluetooth earphone via the slot 103. As various types of charging devices are quite popular in prior art, the present disclosure may therefore be readily implemented by those skilled in the art according to the description herein when various existing charging techniques are adopted.

It should be noted that the embodiment 300 shown in FIG. 3 may directly add the charging apparatus 302 based on the embodiment 100 shown in FIG. 1, which is not shown herein, however, this can be appreciated by those skilled in the art.

The Bluetooth earphones shown in FIGS. 1, 2 or 3, according to embodiments 100, 200 or 300, the profiles thereof are better to match with that of the lodging space on the host device 101. The slot 103 is located at the lodging space for lodging the whole Bluetooth earphone. The description of lodging space will be detailed here below.

It should be noted that similar to the embodiment 100 in FIG. 1, the operating voltages of the Bluetooth earphones 200 and 300 shown in FIGS. 2 and 3 may be 1.2V-3.7V, and the charging voltage may be 3.7V-18.5V. The host device may supply the charging voltage of 3.7V-18.5V accordingly. Similarly, the aforementioned operating voltage and charging voltage of Bluetooth, earphone may be modified in different actual circumstances, which is appreciable to those skilled in the art. The Bluetooth earphone may include, but not limited to, a mono channel Bluetooth earphone, a stereo Bluetooth earphone, or a set of mono channel earphones, including a left channel and a right channel.

### Host Device Using Bluetooth Earphone

A host device using Bluetooth earphone is provided according to the embodiments of the present disclosure in order to be used in conjunction with the aforementioned Bluetooth earphone.

A first issue is to address the function of automatic switch of the Bluetooth earphone. The aforementioned mechanism of automatic switch of the Bluetooth earphone is adopted. The Bluetooth earphone is plugged into a slot of the host device. When not in use, the Bluetooth earphone remains in the slot, whereas the Bluetooth earphone is pulled out of the slot when required for use. The Bluetooth earphone is plugged back to the slot again after use. As such, the usage status may be acquired by simply monitoring the Bluetooth earphone of being “plugged into/pulled out” of the slot (accidentally slipping out or dropping off the Bluetooth earphone from the slot is not considered while only normal usage status is considered herein). The function of automatic switch of the Bluetooth earphone may be realized by using the technique similar to “plug and play” or USB interface of computer system.

As shown in FIG. 4, a schematic view of a host device 400 using Bluetooth earphone according to a first embodiment of the present disclosure is illustrated. The host device 400 includes:
at least one slot 402, each connected to the aforementioned Bluetooth earphone 100;
an earphone status detection apparatus 404 detecting whether the Bluetooth earphone 100 is located in the slot 402. When the earphone status detection apparatus 404 determines that the Bluetooth earphone 100 is located outside the slot 402, a communication channel is built with the Bluetooth earphone 100 and an audio communication channel is transferred to the Bluetooth earphone 100, and then a main audio conversation device (not shown in Figure) of the host device 400 is switched off after successful completion. At this point, as described above, when the Bluetooth earphone 100 is separated from (pulled out of) the slot 402, the detection apparatus 102 of the Bluetooth earphone 100 may perceive and may automatically switch on the power of the Bluetooth earphone 100. Then a connection with the host device 400 may he built successfully and an audio communication channel may be taken over from a main audio conversation device of the main device 400. When the earphone status detection apparatus 404 determines that the Bluetooth earphone 100 is located in the slot 402, the main audio conversation device of the host device 400 is switched on, and the audio communication channel is transferred to the main audio conversation device. Similarly, according to the description above, when the Bluetooth earphone 100 contacts (is plugged into) the slot 402, the detection apparatus 102 of the Bluetooth earphone 100 may perceive and may automatically switch off the power of the Bluetooth earphone 100. As such, the main audio conversation device of the host device 400 may take over the audio communication channel. In general cases, however, when the Bluetooth earphone 100 is plugged back into the slot 402 again, the conversation is already terminated and no transfer of the communication channel is further required. According to the embodiment shown in FIG. 4, the Bluetooth earphone 100 further includes a slot 104 for matching with the slot 402 of the host device 400.

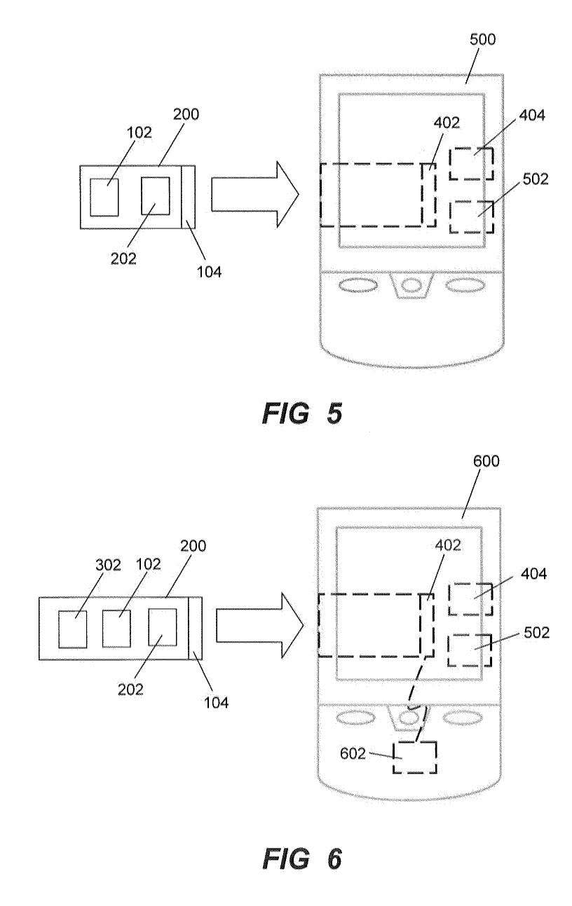

Then, an automatic matching and connection building shall also be concerned for the host device. As shown in FIG. 5, a schematic view of a host device 500 using Bluetooth earphone according to a second embodiment of the present disclosure is illustrated, namely a further optimization for the embodiment shown in FIG. 4. The function of automatic matching is added therein. Correspondingly, the host device 500 works in conjunction with the Bluetooth earphone shown in the above embodiment 200. As shown in FIG. 5, based on the embodiment 400 in FIG. 4 (the description of same components as those of the embodiment 400 in FIG. 4 is omitted herein), an earphone automatic connection enabling apparatus 502 is further added to a Bluetooth earphone 400, automatic connection enabling apparatus. The earphone automatic connection enabling apparatus 502 automatically builds a connection with the Bluetooth earphone 200 when the earphone status detection apparatus 404 indicates that the Bluetooth earphone 200 is located outside the slot 402. It can be appreciated that the connection is built between the earphone automatic connection enabling apparatus 502 of the host device 500 and the automatic connection apparatus 202 of the Bluetooth earphone 200. According to the description above, when the Bluetooth earphone 200 is pulled out of the slot 402, the detection apparatus 102 may indicate the automatic connection apparatus 202 to automatically build a connection with the host device 500. It should be noted that when the Bluetooth earphone 200 is plugged into the slot 402 and matching is not performed yet, the earphone automatic connection enabling apparatus 502 will match with the automatic connection apparatus 202 of the Bluetooth earphone 200. Then, the connection is built automatically when the Bluetooth earphone 200 is pulled out of the slot 402. The procedure of automatic connection building is similar to that of the manual operation, however, automatic connection may be realized by using information of the Bluetooth earphone and PIN code information stored in the host device. This procedure is operated in a way similar to that of storing the account number and key in computer for automatic login, which is fully achievable to those skilled in the art.

The charging for Bluetooth earphone is yet another issue to be addressed. The charging for Bluetooth earphone is handed over to the host device according to the embodiments of the present disclosure, thus no separate charger is needed for charging. Consequently, the charging for host device and Bluetooth earphone will be performed synchronously such that the charging period of the two devices may be synchronous. Moreover, according to the design of the present disclosure, the host device may charge the Bluetooth earphone by host device battery or by external power source of the host device. Therefore, the Bluetooth earphone itself may be designed to have a low battery capacity which is adequate to support a certain conversation period. When located at the socket of host device, the Bluetooth earphone will be charged by the host device until full. Since the host device may use its own battery to charge the Bluetooth earphone, standby period of the two devices may be substantially synchronous accordingly.

Consequently, as shown in FIG. 6, a further optimization for the host device is proposed. Referring to FIG. 6, a schematic view of a host device according to a third embodiment 600 is illustrated. Correspondingly, the host device 600 works in conjunction with the Bluetooth earphone 300. As shown in FIG. 6, based on the embodiment 500 in FIG. 5 (the description of same components as those of the embodiment 500 in FIG. 5 is omitted herein), a host device 600 further includes an earphone charging apparatus 602, where the earphone charging apparatus 602 charges the Bluetooth earphone 300 via the slot 402. When the earphone status detection apparatus 404 determines that the Bluetooth earphone is located in the slot 402, the earphone charging apparatus 602 switches on the charging channel for the Bluetooth earphone 300, such that the charging apparatus 302 of the Bluetooth earphone 300 automatically detects whether charging is required. When the earphone status detection apparatus 404 determines that the Bluetooth earphone 300 is located outside the slot 402, the earphone charging apparatus 602 switches off the charging channel of the Bluetooth earphone 300. Similarly, as various types of charging devices are quite popular in prior art, the present disclosure can therefore be readily implemented by those skilled in the art according to the description herein when various existing charging techniques are adopted. Preferably, the host device 600 may charge the Bluetooth earphone by host device battery (not shown in Figure) or by external power source (not shown in Figure). Since the Bluetooth earphone is not required to be standby for a long period, battery of relatively low capacity may be adopted. As such, the host device may use its own battery to charge the Bluetooth earphone. When the host device battery is almost exhausted, meanwhile, the host device may on longer continue to charge the battery for Bluetooth earphone. Therefore, the charging period of the two devices can basically be synchronous. During the charging period of the host device, external power source of the host device may perform the charging as well if the Bluetooth earphone is placed at the slot. Thus, the charging period of the host device is substantially unaffected due to low battery capacity of the Bluetooth earphone.

It should be noted that the embodiment 600 shown in FIG. 6 may directly add the charging apparatus 602 based on the embodiment 400 shown in FIG. 4, which is not shown herein, however, this is readily appreciated by those skilled in the art.

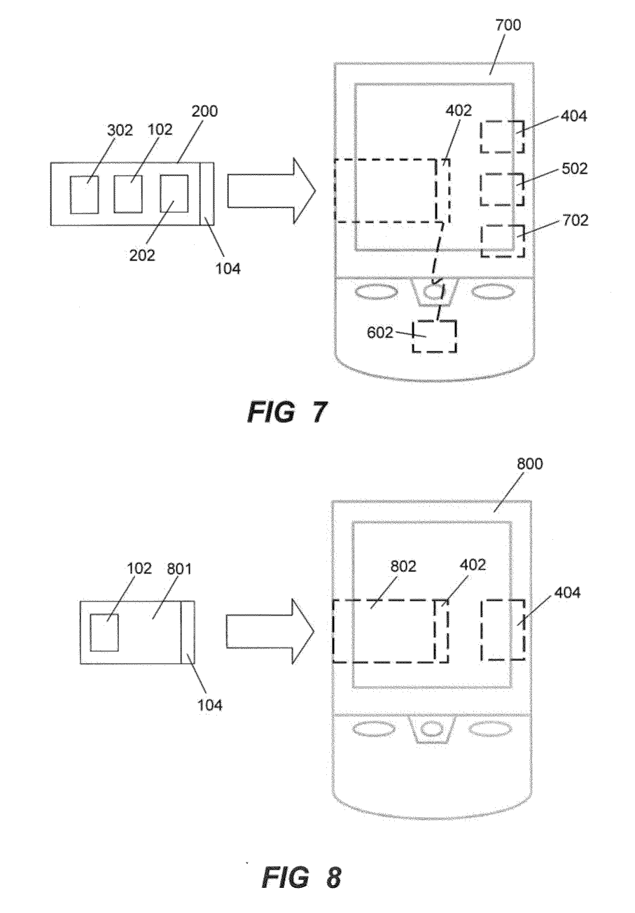

As shown in FIG. 7, a fourth embodiment 700 of host device is illustrated in FIG. 7, which is a further optimization based on the host device 600 which has a charging function, a selection function is provide to the user. As shown in FIG. 7, based on the embodiment 600 in FIG. 6 (the description of same components as those of the embodiment 600 in FIG. 6 is omitted herein), the host device 700 further includes an automatic control switch 702, when the automatic control switch 702 is switched on, the host device 700 transfers the audio communication channel and provides the charging channel based on a determination result conducted by the earphone status detection apparatus 404. When the automatic control switch 702 is switched off, the host device 700 merely provides the charging channel based on the determination by the earphone status detection apparatus 404. In other words, the user may select to switch off the function of automatic switch based on the status of plug into/pulled out, but remain its function of charging only.

In order to provide the Bluetooth earphone with a better protection and reduce the possibility of the loss of the Bluetooth earphone, embodiments of the present disclosure provide a lodging space in the host device for lodging the Bluetooth earphone. As shown in FIG. 8, a fifth embodiment 800 of the host device is illustrated in FIG. 8. It should be noted that although FIG. 8 is illustrated on basis of the host device 400 shown in FIG. 4, as is appreciated by those skilled in the art, all the aforementioned embodiments 400-700 may server as the base of the embodiment 800.

As shown in FIG. 8, the host device 800 has at least one lodging space 802, where the figure of the lodging space matches with that of the Bluetooth earphone 801 (or any of the Bluetooth earphone shown in the embodiments 100-300). Each lodging space 802 has a slot 402, and the lodging space is capable of lodging the whole Bluetooth earphone 801. Generally, one host device 800 has one lodging space 802 for lodging one Bluetooth earphone 801.

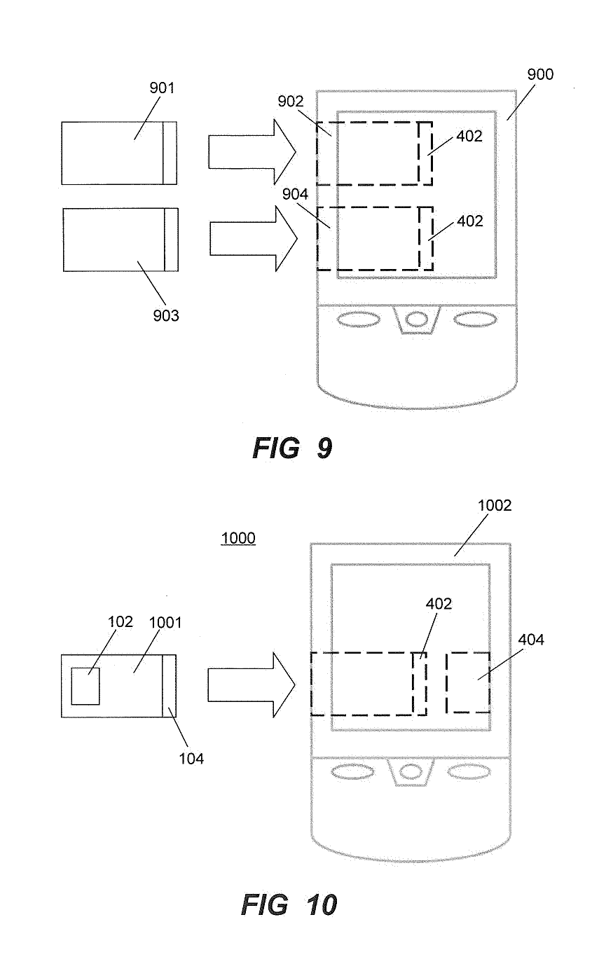

If a pair of Bluetooth earphones are provided, i.e., stereo earphones with two mono channels (a left channel earphone and tight channel earphone), embodiment 900 shown in FIG. 9 may be adopted. The embodiment 900 is a variation made from the host device in embodiment 800. The host device 900 includes two lodging spaces 902 and 904, each having a slot 402; the two lodging spaces 902 and 904 lodge one of the Bluetooth earphone pair 901 and 903 respectively, including a left channel earphone 901 and a right channel earphone 903. The embodiment 800 and the embodiment 900 share the same features other than the number of lodging space.

With respect to the aforementioned host devices 600 and 700 with the function of charging, the host device supplies a charging voltage of 3.7V-18.5V, while the operating voltage of the Bluetooth earphone is 1.2V-3.7V. It should be noted that the aforementioned operating voltage supplied by the host device and charging voltage of Bluetooth earphone may be modified in different actual circumstances, which is appreciable to those skilled in the art.

With respect to any of the aforementioned host devices 400-900, the host device may include, but no limited to, various personal terminals such as a mobile phone, a PDA, a notebook, etc.

### Host Device Having Bluetooth Earphone

The above description introduces the Bluetooth earphone and the host device used accompanying with the Bluetooth earphone according to the embodiments of the present disclosure. Such two components may be used separately. That is, the technique of the present disclosure may be applied to the Bluetooth earphone or the host device only. Or, the technique of the present disclosure may be applied together, i.e., to provide the host device having the Bluetooth earphone.

All the embodiments to be introduced below are host devices having Bluetooth earphone.

Firstly, as shown in FIG. 10, embodiment 1000 of a host device having a Bluetooth earphone is illustrated, which provides the function of automatic switch of off the Bluetooth earphone. It may be appreciated that embodiment 1000 is a combination of the Bluetooth earphone in embodiment 100 and the host device in embodiment 400. The mechanism of automatic switch of the Bluetooth earphone is provided thereof. The Bluetooth earphone is plugged into a slot of the host device. When not in use, the Bluetooth earphone remains in the slot, whereas the Bluetooth earphone is pulled out of the slot when required for use. The Bluetooth earphone is plugged back to the slot again after use. As such, the usage status may he acquired by simply monitoring the action in terms of the Bluetooth earphone of being “plugged into/pulled out” of the slot (accidentally slipping out or dropping off the Bluetooth earphone from the slot is not considered while normal usage status is merely considered herein). The function of automatic switch of the Bluetooth earphone may be realized by using the technique similar to “plug and play” or USB interface of computer system.

As shown in FIG. 10, a host device 1000 having a Bluetooth earphone includes: a Bluetooth earphone 1001, which may be the Bluetooth earphone in embodiment 100. Besides the same basic structure as existing Bluetooth earphone (the basic structure is well-known skill in the art and is omitted herein for brevity), the Bluetooth earphone 1001 further includes: a detection apparatus 102 for detecting whether the Bluetooth earphone 1001 is located in the slot 402. When the Bluetooth earphone 1001 is located in the slot 402, the detection apparatus 102 instructs the Bluetooth earphone 1001 to switch off the power. When the Bluetooth earphone 1001 is located outside the slot 402, the detection apparatus 102 instructs the Bluetooth earphone 1001 to switch on the power. The Bluetooth earphone 1001 may realize an automatic switch based on the detection apparatus 102. When the Bluetooth earphone 1001 is located in the slot 402, indicating that the Bluetooth earphone 1001 is not in use, its power is therefore switched off to save capacity. When the detection apparatus 102 determines that the Bluetooth earphone 1001 is located outside the slot 402, indicating that the Bluetooth earphone 1001 is pulled out and should be in use, the detection apparatus 102 then instructs the Bluetooth earphone 1001 to switch on the power for use. When the Bluetooth earphone 100 is placed back to the slot 402 after use, the detection apparatus 102 determines that the Bluetooth earphone 1001 is not in use, and then switches off the power of Bluetooth earphone 1001 again. As mentioned above, such monitoring of “plug into/pull out” is achievable using the technique of “plug and play” or USB interface according to the existing computer system. Therefore, the transplantation of such technique into the Bluetooth earphone 1001 is fully achievable to those skilled in the art. Consequently, it is important that an implementation thereof is provided according to the present disclosure, i.e., achieving the control of automatic turning on/turning off Bluetooth earphone by monitoring “plug into/pull out” of Bluetooth earphone. However, the present disclosure is not intended to limit its specific solutions, e.g., specific circuit and control software, which are achievable to those skilled in the art when the existing techniques are adopted. Similar to the embodiment 100 shown in FIG. 1, the Bluetooth earphone 1001 of the host device 1000 having a Bluetooth earphone further includes at least one socket 104, where the at least one socket 104 matches with the slot 402, when the at least one socket 104 is in contact with the slot 402, the detection apparatus 102 determines that the Bluetooth earphone 1001 is located in the slot 402, when the at least one socket 104 is separated from the slot 402, the detection apparatus 102 determines that the Bluetooth earphone 1001 is located outside the slot. It should be noted that although only one socket 104 is illustrated in the Figure, as can he appreciated, the Bluetooth earphone 1001 may further include a plurality of sockets 104 that measure with various standards in order to match with possibly different slot 402 of the host device 1000. The host device may include various personal terminals such as a mobile phone, a PDA, a notebook, etc. Accordingly, these terminals may have various types of slots, such that the Bluetooth earphone 1001 proposed by the embodiments of the present disclosure may have a plurality of different sockets to facilitate the generality of Bluetooth earphone 1001.

Back to FIG. 10, referring to the embodiment 1000 again, the host device 1002 of the host device 1000 having a Bluetooth earphone may be interpreted as corresponding to the host device using Bluetooth earphone in embodiment 400. The host device 1002 includes:
at least one slot 402, each connected to the aforementioned Bluetooth earphone 1001;
an earphone status detection apparatus 404 detecting whether the Bluetooth earphone 1001 is located in the slot 402. When the earphone status detection apparatus 404 determines that the Bluetooth earphone 1001 is located outside the slot 402, a communication channel is built with the Bluetooth earphone 1001 and an audio communication channel is transferred to the Bluetooth earphone 1001, and then a main audio conversation device (not shown in Figure) of the host device 1002 is switched off after a successful completion. At this point, as described above, when the Bluetooth earphone 1001 is separated from (pulled out of) the slot 402, the detection apparatus 102 of the Bluetooth earphone 1001 may perceive and may automatically switch on the power of the Bluetooth earphone 1001. A connection with the host device 1002 may then be built successfully and the audio communication channel is taken over from a main audio conversation device of the main device 1002. When the earphone status detection apparatus 404 determines that the Bluetooth earphone 1001 is located outside the slot 402, the main audio conversation device of the host device 1002 is switched on, and the audio communication channel is transferred to the main audio conversation device. Similarly, according to the description above, when the Bluetooth earphone 1001 contacts (is plugged into) the slot 402, the detection apparatus 102 of the Bluetooth earphone 1001 may perceive and may automatically switch off the power of the Bluetooth earphone 1001. As such, the main audio conversation device of the host device 1002 may take over the auto communication channel. In general cases, however, when the Bluetooth earphone 1001 is plugged back into the slot 402 again, the conversation is already terminated and no transfer of the communication channel is further required.

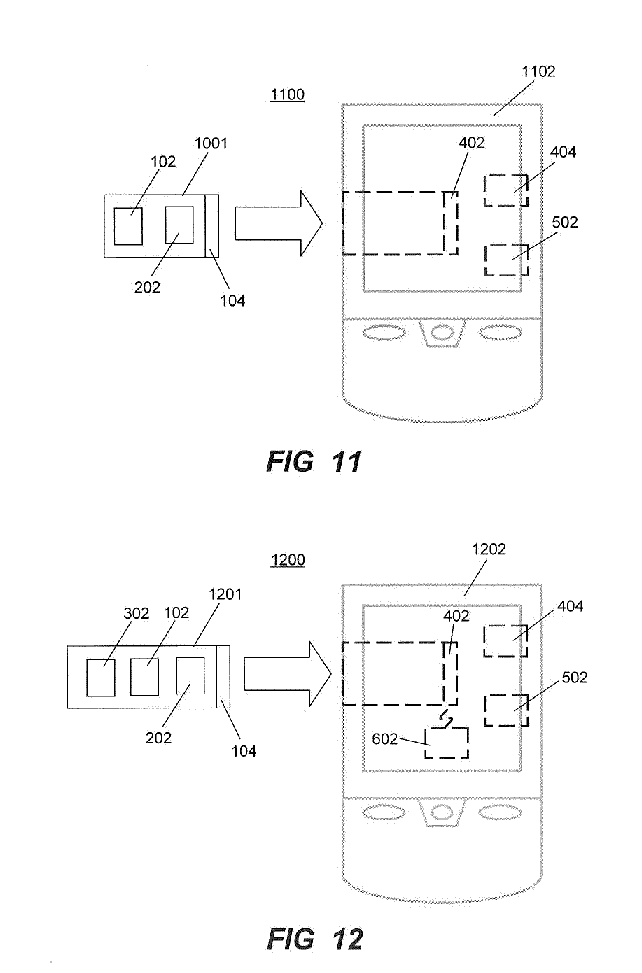

Similarly, in terms of the Bluetooth earphone and the host device, after achieving the automatic switch, the next issue to be addressed is automatic matching and connection building. In prior art, connection building requires a manual search by user, a selection of the Bluetooth earphone, an input of PIN code of the host device, which is quite a time-consuming and laborious procedure. Therefore, an optimization thereof is also provided according to the embodiments of the present disclosure. As shown in FIG. 11, embodiment 1100 is a further improvement based on the embodiment 1000, mainly configured to solve the problem of automatic matching.

Firstly, it can be appreciated that a Bluetooth earphone 1101 therein corresponds to the Bluetooth earphone 200 in FIG. 2, where the function of automatic matching and automatic connecting is added into the Bluetooth earphone 1101. Based on the embodiment 1001 in FIG. 10 (the description of same components as those of the embodiment 1001 in FIG. 10 is omitted herein), the Bluetooth earphone 1101 further includes an automatic connection apparatus 202 for automatically matching with the host device 1102 when the detection apparatus 102 indicates that the Bluetooth earphone 1101 is located in the slot 402 and no matching is performed yet. The automatic connection apparatus 202 further automatically builds a connection with the-host device 1102 when the detection apparatus 102 indicates that the Bluetooth earphone 1101 is located outside the slot 402. The procedure of automatic matching and connection building is similar to that of the manual operation, however, automatic connection may be realized by using information of the Bluetooth earphone and PIN code information stored in the host device. This procedure is operated in a way similar to that of storing the account number and key in computer for automatic login, which is fully achievable to those skilled in the art.

Accordingly, the host device in embodiment 1100 may be interpreted as corresponding to the host device embodiment 500 illustrated in conjunction with FIG. 5. The host device in embodiment 1100 is a further improvement for the host device 1002 in FIG. 10 with the function of automatic matching added therein. As shown in FIG. 11, based on the host device 1002 in FIG. 10 (the description of same components as those of host device 1002 in FIG. 10 is omitted herein), host device 1102 further includes an earphone automatic connection enabling apparatus 502 for automatically building a connection with the Bluetooth earphone 1101 when the earphone status detection apparatus 404 indicates that the Bluetooth earphone 1101 is located outside the slot 402. It can be appreciated that the connection is built between the earphone automatic connection enabling apparatus 502 of the host device 1102 and the automatic connection apparatus 202 of the Bluetooth earphone 1101. According to the description above, when the Bluetooth earphone 1101 is pulled out of the slot 402, the detection apparatus 102 may indicate the automatic connection apparatus 202 to automatically build a connection with the host device 1102. It should be noted that when the Bluetooth earphone 1101 is plugged into the slot 402 and the matching is not performed yet, the earphone automatic connection enabling apparatus 502 will match with the automatic connection apparatus 202 of the Bluetooth earphone 1101. Then, the connection is built automatically when the Bluetooth earphone 1101 is pulled out of the slot 402. The procedure of automatic matching and connection building is similar to that of the manual operation, however, automatic connection may be realized by using information of the Bluetooth earphone and PIN code information stored in the host device. This procedure is operated in a way similar to that of storing the account number and key in computer for automatic login, which is fully achievable to those skilled in the art.

As shown in FIG. 12, an embodiment 1200 of a host device is illustrated, where the problem of charging for Bluetooth earphone is resolved. The charging for Bluetooth earphone is handed over to the host device according to the present disclosure, thus no separate charger is needed for charging. Consequently, the charging for host device and Bluetooth earphone will be performed synchronously such that the charging period of the two devices can be synchronous. Moreover, according to the design of the present disclosure, the host device may charge the Bluetooth earphone by host device battery. Therefore, the Bluetooth earphone itself may be designed to,have a low battery capacity which is adequate to support a certain conversation period. When located at the socket of host device, the Bluetooth earphone will be charged by the host device until full. Since the host device may use its own battery or external power source of the host device to charge the Bluetooth earphone, standby period of the two devices may be substantially synchronous accordingly.

As shown in FIG. 12, the Bluetooth earphone 1201 in the embodiment 12 shown in FIG. 12 may be interpreted as corresponding to the Bluetooth earphone 300 in embodiment 300 shown in FIG. 3, where the function of automatic charging is also added into the Bluetooth earphone 1201.

As shown in FIG. 12, based on the Bluetooth earphone 1101 in FIG. 11 (the description of same components as those of the Bluetooth earphone 1101 in FIG. 11 is omitted herein), the Bluetooth earphone 1201 further includes a charging apparatus 11, where the charging apparatus 302 matches with the slot 402 via which charging for the Bluetooth earphone 1201 is performed by the host device 1202. When the detection apparatus 102 indicates that the Bluetooth earphone is located in the slot 402, the charging apparatus 302 of the Bluetooth earphone 1201 automatically detects whether charging is required. When the charging is required, the charging apparatus 302 automatically charges the Bluetooth earphone 1201 via the slot 402 by the host device 1202. Further referring to FIG. 12, the charging apparatus 302 is connected to the at least one socket 104 through which the host device 1202 charges the Bluetooth earphone 1201 via the slot 402. As various types of charging devices are quite popular in prior art, the present disclosure can therefore be readily implemented by those skilled in the art according to the description herein when various existing charging techniques are adopted. It should be noted that the embodiment 1201 shown in FIG. 12 may directly add the charging apparatus 302 based on the embodiment 1001 shown in FIG. 10, which is not shown herein, however, this is readily appreciated by those skilled in the art.

Similarly, the improvement is also made for the host device 1202 in the embodiment. As shown in FIG. 12, the host device 1202 may be interpreted as corresponding to the host device in the embodiment 600 shown in FIG. 6. Based on the host device 1102 in FIG. 11 (the description of same components as those of the host device 1102 in FIG. 11 is omitted herein), the host device 1202 further includes an earphone charging apparatus 602, where the earphone charging apparatus 602 charges the Bluetooth earphone 1201 via the slot 402. When the earphone status detection apparatus 404 determines that the Bluetooth earphone is located in the slot 402, the earphone charging apparatus 602 switches on a charging channel for the Bluetooth earphone 1201, such that the charging apparatus 302 of the Bluetooth earphone 1201 automatically detects whether charging is required. When the earphone status detection apparatus 404 determines that the Bluetooth earphone 1201 is located outside the slot 402, the earphone charging apparatus 602 switches off the charging channel for the Bluetooth earphone 1201. Similarly, as various types of charging devices are quite popular in prior art, the present disclosure can therefore be readily implemented by those skilled in the art according to the description herein when various existing charging techniques are adopted. Preferably, the host device 1202 may charge the Bluetooth earphone 1201 by host device battery (not shown in Figure) or by external power source of the host device 1202. Since the Bluetooth earphone is not required to be standby for a long period, battery of relatively low capacity may be adopted. As such, the host device may use its own battery to charge the Bluetooth earphone. When the host device battery is almost exhausted, meanwhile, the host device may on longer continue to charge the battery for Bluetooth earphone. Therefore, the charging period of the two devices may basically be synchronous. During the charging period for the host device by external power source, the Bluetooth earphone will be charged together if it is placed at the slot. Thus, the charging period of the host device is substantially unaffected due to low battery capacity of the Bluetooth earphone. It should be noted that the host device 1202 shown in FIG. 12 may directly add the charging apparatus 602 based on the host device 1002 shown in FIG. 10, which is not shown herein, however, this is readily appreciated by those skilled in the art.

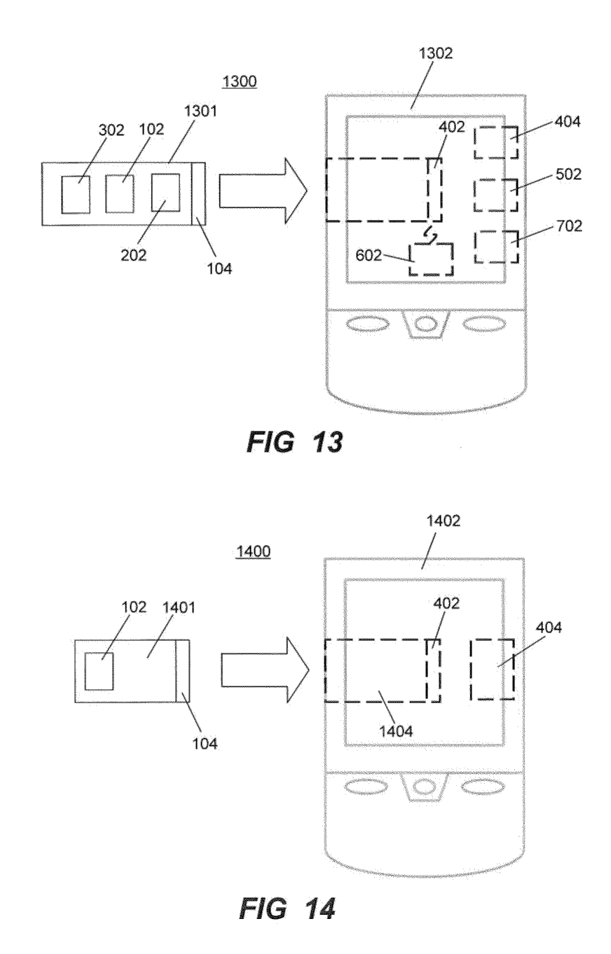

As shown in FIG. 13, a fourth embodiment 1300 of a host device having a Bluetooth earphone is illustrated in FIG. 13, which is a further improvement based on the host device 1200 with charging function and may provide the user with a selection function. As shown in FIG. 13, based on the embodiment 1200 in FIG. 12 (the description of same components as those of the embodiment 1200 in FIG. 12 is omitted herein), the host device 1300 further includes an automatic control switch 702, when the automatic control switch 702 is switched on, the host device 700 transfers an audio communication channel and provides a charging channel based on a determination result conducted by the earphone status detection apparatus 404; when the automatic control switch 702 is switched off, the host device 700 merely provides the charging channel based on the determination by the earphone status detection apparatus 404. In other words, the user may select to switch off the function of automatic switch based on the status of plugging into/pulling out of the Bluetooth earphone, but remain the function of charging only. Other components such as the Bluetooth earphone 1030 and the host device 1302 are the same as those of the embodiment 1200.

In order to provide the Bluetooth earphone with a better protection and reduce the possibility of the loss of the Bluetooth earphone, embodiments of the present disclosure provide a lodging space in the host device for lodging the Bluetooth earphone. As shown in FIG. 14, a fifth embodiment 1400 of the host device having Bluetooth earphone is illustrated in FIG. 14. It should be noted that although FIG. 14 is illustrated on basis of the host device 1000 shown in FIG. 10, as is appreciated by those skilled in the art, all the aforementioned embodiments 1000-1300 may server as the base of the embodiment 1400.

As shown in FIG. 14, the host device 1402 of the host device 1400 has at least one lodging space 1404, where the profile of the lodging space matches with that of the Bluetooth earphone 1401 (or any of the Bluetooth earphone shown in the embodiment 100-300). Each lodging space 1404 has a slot 402, and the lodging space is capable of lodging the whole Bluetooth earphone 1401. Generally, one host device 1400 has one lodging space 1404 for lodging one Bluetooth earphone 1401.

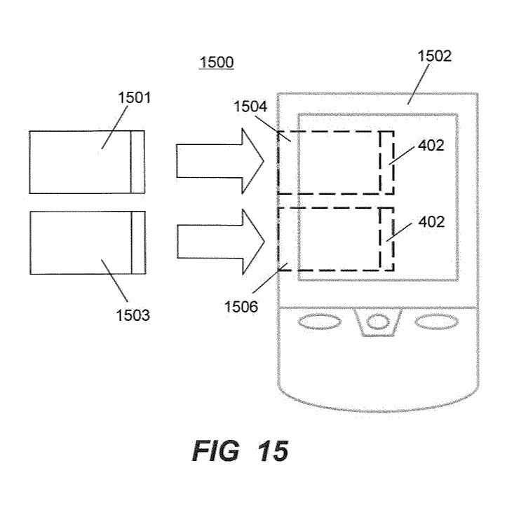

If a pair of Bluetooth earphones are provided, i.e., stereo earphones with two mono channels (a left channel earphone and a right channel earphone), embodiment 1500 shown in FIG. 15 may be adopted. The host device 1502 of the embodiment 1500 is a variation made from the host device 1402 of the embodiment 1400. The host device 1502 of the host device 1500 includes two lodging spaces 1504 and 1506, each having a slot 402; the two lodging spaces 1504 and 1506 lodge one of the Bluetooth earphone pair 1501 and 1503 respectively, including a left channel earphone 1501 and a right channel earphone 1503. The embodiment 1500 and the embodiment 1400 share the same features other than the number of lodging space.

It should be noted that all of the Bluetooth earphones in the aforementioned embodiments 1000-1500 may share the voltage characteristic as follows: the operating voltage of the Bluetooth earphone is 1.2V-3.7V, and the charging voltage supplied by the host device is 3.7V-18.5V. Accordingly, all of the host devices may share the voltage characteristic as follows: a charging voltage of 3.7V-18.5V being supplied by the host device to charge the Bluetooth earphone with an operating voltage of 1.2V-3.7V. It should be noted that the aforementioned operating voltage supplied by the host device and charging voltage of Bluetooth earphone may be modified in different actual circumstances, which is appreciable to those skilled in the art.

Similarly, in the aforementioned embodiments 1000-1500, the Bluetooth earphone includes, but not limited to, a mono channel Bluetooth earphone, or a stereo Bluetooth earphone. The host device therein includes, but not limited to, a mobile phone, a PDA, or a notebook.

According to the embodiments of the present disclosure, the function of automatic switch of the Bluetooth earphone is provided, so that the Bluetooth earphone and the host device may perceive each other. When the Bluetooth earphone is in use, the earphone and the Bluetooth module of the host device will be switches on automatically, and a connection will also be built automatically. When the Bluetooth earphone is not in use, the earphone and the Bluetooth module of the host device will be switched off automatically to save power. Furthermore, the Bluetooth earphone will no longer use a separate charging device, instead, the host device will take the responsibility for charging the Bluetooth earphone. As such, the two devices may share substantially the same standby/usage period and charging period. Also, there is no need to carry two chargers any more. Moreover, lodging space at the host device is provided for lodging the Bluetooth earphone. When not in use, the Bluetooth earphone may be placed at the lodging space. Accordingly, the Bluetooth earphone will no longer be nowhere to be found.

The foregoing embodiments are provided to those skilled in the art for implementation or usage of the present disclosure. Various modifications or alternations may be made by those skilled in the art without departing from the spirit of the present disclosure. Therefore, the foregoing embodiments shall not be construed to be limiting to the scope of present disclosure. The scope of the present disclosure should be construed as the largest scope in accordance with innovative characters mentioned in the claims.

What is claimed is:

1. A Bluetooth earphone, wherein,
the Bluetooth earphone is placed in a slot of a host device using the Bluetooth earphone; and
the Bluetooth earphone comprises a detection apparatus for detecting whether the Bluetooth earphone is located in the slot, wherein when the Bluetooth earphone is located in the slot, the detection apparatus instructs the Bluetooth earphone to switch off the power, and when the Bluetooth earphone is located outside the slot, the detection apparatus instructs the Bluetooth earphone to switch on the power.

2. The Bluetooth earphone of claim 1, wherein the Bluetooth earphone comprises an automatic connection apparatus for automatically matching with the host device using the Bluetooth earphone when the detection apparatus indicates that the Bluetooth earphone is located in the slot and no matching is performed yet.

3. The Bluetooth earphone of claim 2, wherein the Bluetooth earphone comprises a charging apparatus for matching with the slot, wherein the host device using the Bluetooth earphone charges the Bluetooth earphone via the slot.

4. The Bluetooth earphone of claim 3, wherein the charging apparatus of the Bluetooth earphone automatically detects whether charging is required when the detection apparatus indicates that the Bluetooth earphone is located in the slot, and when the charging is required, the charging apparatus automatically charges the Bluetooth earphone via the slot by the host device using the Bluetooth earphone.

5. The Bluetooth earphone of claim 4, wherein
the Bluetooth earphone has at least one socket, wherein the at least one socket matches with the slot, and the detection apparatus determines that the Bluetooth earphone is located in the slot when the at least socket is in contact with the slot, whereas the detection apparatus determines that the Bluetooth earphone is located outside the slot when the at least socket is separated from the slot; and
the charging apparatus is connected to the at least one socket, wherein the host device using the Bluetooth earphone charges the Bluetooth earphone via the socket and the slot.

6. The Bluetooth earphone of any of claims 1-5, wherein a profile of the Bluetooth earphone matches with that of a lodging space on the host device using the Bluetooth earphone, wherein the slot is located in the lodging space which lodges the whole Bluetooth earphone.

7. The Bluetooth earphone of claim 6, wherein an operating voltage of the Bluetooth earphone is 1.2V-3.7V and the charging is performed by the host device.

8. The Bluetooth earphone of claim 7, wherein the Bluetooth earphone comprises a mono channel Bluetooth earphone or a stereo Bluetooth earphone.

9. A host device using Bluetooth earphone, comprising:
at least one slot, each slot connected to the Bluetooth earphone of claim 1; and
an earphone status detection apparatus, for detecting whether the Bluetooth earphone is located in the slot, wherein when the earphone status detection apparatus determines that the Bluetooth earphone is located outside the slot, a communication channel is built with the Bluetooth earphone and an audio communication channel is transferred to the Bluetooth earphone, and then a main audio conversation device of the host device is switched off after successful completion; when the earphone status detection apparatus determines that the Bluetooth earphone is located in the slot, the main audio conversation device of the host device is switched on, and the audio communication channel is transferred to the main audio conversation device.

10. The host device of claim 9, wherein the host device comprises an earphone automatic connection enabling apparatus for automatically building a connection with the Bluetooth earphone when the earphone status detection apparatus indicates that the Bluetooth earphone is located outside the slot.

11. The host device of claim 10, wherein the host device comprises an earphone charging apparatus for charging the Bluetooth earphone via the slot, wherein the earphone charging apparatus switches on the charging channel for the Bluetooth earphone when the earphone status detection apparatus determines that the Bluetooth earphone is located in the slot, a charging apparatus of the Bluetooth earphone automatically detects whether charging is required; the earphone charging apparatus switches off the charging channel for the Bluetooth earphone when the earphone status detection apparatus determines that the Bluetooth earphone is located outside the slot.

12. The host device of claim 11, wherein the host device charges the Bluetooth earphone by host device battery or by external power source of the host device.

13. The host device of claim 12, wherein the host device comprises an automatic control switch, wherein when the automatic control switch is switched on, the host device transfers the audio communication channel and provides the charging channel based on a determination result conducted by the earphone status detection apparatus; when the automatic control switch is switched off, the host device merely provides the charging channel based on the determination by the earphone status detection apparatus.

14. The host device of any of claims 9-13, wherein the host device has at least one lodging space, with a profile matches with that of the Bluetooth earphone, wherein each lodging space has a slot and lodges the whole Bluetooth earphone.

15. The host device of claim 14, wherein the host device comprises two lodging spaces, each having a slot; wherein the two lodging spaces lodge one of a Bluetooth earphone pair respectively, including a left channel earphone and a right channel earphone.

16. The host device of claim 15, wherein a charging voltage supplied by the host device is 3.7V-18.5V, and an operating voltage of the Bluetooth earphone is 1.2V-3.7V.

17. The host device of claim 16, wherein the host device comprises a mobile phone, a Personal Digital Assistant, and a notebook.

18. A host device having Bluetooth earphone, comprising:
a Bluetooth earphone, which has a detection apparatus for detecting whether the Bluetooth earphone is located in the slot, wherein the detection apparatus instructs the Bluetooth earphone to switch off the power when the Bluetooth earphone is located in the slot, the detection apparatus instructs the Bluetooth earphone to switch on the power when the Bluetooth earphone is located outside the slot;
at least one slot, each connected to the Bluetooth earphone; and
an earphone status detection apparatus for detecting whether the Bluetooth earphone is located in the slot, wherein when the earphone status detection apparatus determines that the Bluetooth earphone is located outside the slot, a communication channel is built with the Bluetooth earphone and an audio communication channel is transferred to the Bluetooth earphone, and then a main audio conversation device of the host device is switched off after successful completion; when the earphone status detection apparatus determines that the Bluetooth earphone is located in the slot, the main audio conversation device of the host device is switched on, and the audio communication channel is transferred to the main audio conversation device.

19. The host device of claim 18, wherein
the Bluetooth earphone comprises an automatic connection apparatus for automatically matching with the host device using the Bluetooth earphone when the detection apparatus indicates that the Bluetooth earphone is located in the slot and no matching is performed yet; wherein the automatic connection apparatus automatically builds a connection with the host device when the detection apparatus indicates that the Bluetooth earphone is located outside the slot; and
the host device comprises an earphone automatic connection enabling apparatus for automatically building a connection with the Bluetooth earphone when the earphone status detection apparatus indicates that the Bluetooth earphone is located outside the slot.

20. The host device of claim 19, wherein
the Bluetooth earphone comprises a charging apparatus for matching with the slot, wherein the host device using the Bluetooth earphone charges the Bluetooth earphone via the slot, when the detection apparatus indicates that the Bluetooth earphone is located in the slot, the charging apparatus of the Bluetooth earphone automatically detects whether charging is required; when the charging is required, the charging apparatus automatically charges the Bluetooth earphone via the slot by the host device using the Bluetooth earphone; and
the host device comprises an earphone charging apparatus for charging the Bluetooth earphone via the slot, and the earphone charging apparatus switches on the charging channel for the Bluetooth earphone when the earphone status detection apparatus determines that the Bluetooth earphone is located in the slot, the charging apparatus of the Bluetooth earphone automatically detects whether charging is required; whereas the earphone charging apparatus switches off the charging channel for the Bluetooth earphone when the earphone status detection apparatus determines that the Bluetooth earphone is located outside the slot.

21. The host device of claim 20, wherein
the Bluetooth earphone comprises at least one socket, for matching with the slot, and the detection apparatus determines that the Bluetooth earphone is located in the slot when the at least one socket is in contact with the slot, wherein the detection apparatus determines that the Bluetooth earphone is located outside the slot when the at least one socket is separated from the slot; and
the charging apparatus is connected to the at least one socket, wherein the he host device using the Bluetooth earphone charges the Bluetooth earphone via the socket and the slot.

22. The host device of claim 21, wherein the host device charges the Bluetooth earphone by host device battery or by external power source of the host device.

23. The host device of claim 22, wherein the host device comprises an automatic control switch, wherein when the automatic control switch is switched on, the host device transfers the audio communication channel and provides the charging channel based on a determination result conducted by the earphone status detection apparatus; when the automatic control switch is switched off, the host device merely provides the charging channel based on the determination by the earphone status detection apparatus.

24. The host device of any of claims 18-23, wherein the host device has at least one lodging space with a profile matching with that of the Bluetooth earphone, wherein each lodging space has a slot and lodges the whole Bluetooth earphone.

25. The host device of claim 24, wherein the host device comprises two lodging spaces, each having a slot; the two lodging spaces lodge one of a Bluetooth earphone pair respectively, including a left channel earphone and a right channel earphone.

26. The host device of claim 24, wherein an operating voltage of the Bluetooth earphone is 1.2V-3.7V, and a charging voltage supplied by the host device is 3.7V-18.5V.

27. The host device of claim 24, wherein the Bluetooth earphone comprises a mono channel Bluetooth earphone or a stereo Bluetooth earphone.

28. The host device of claim 24, wherein the host device comprises a mobile phone, a Personal Digital Assistant, and a notebook.
